(19) United States
(12) Patent Application Publication
(10) Pub. No.: US 2024/0338024 A1
(43) Pub. Date: Oct. 10, 2024

(54) Autonomous Driving Control Apparatus, System Including The Same, And Method Thereof

(71) Applicants: Hyundai Motor Company, Seoul (KR); Kia Corporation, Seoul (KR)

(72) Inventors: Yun Sub Kim, Suwon-Si (KR); Seung Yong Lee, Uiwang-Si (KR); Ga Hee Kim, Seoul (KR); Hwan Hee Lee, Gunpo-Si (KR)

(21) Appl. No.: 18/375,067

(22) Filed: Sep. 29, 2023

(30) Foreign Application Priority Data
Apr. 10, 2023 (KR) 10-2023-0046876

(51) Int. Cl. G05D 1/02; G06T 7/80; G06V 20/52; G06V 20/62; G06V 30/10; G08G 1/017

(52) U.S. Cl. CPC G05D 1/0246; G06T 7/80; G06V 20/52; G06V 20/625; G06V 30/10; G08G 1/017

(57) ABSTRACT

Disclosed is an autonomous driving control apparatus which includes a sensor device, a communication device, a memory storing instructions, and a controller. For example, the autonomous driving control apparatus controls a mobility device to a specified place and obtains image data about at least one vehicle in the specified place using the sensor device, detects location information about each of the at least one vehicle using the image data, receives identification information corresponding to each of the at least one vehicle from a server, using the communication device, and calibrates the sensor device using any one of the location information, the identification information, an error between the location information and the identification information, or a combination thereof, when the error between the location information and the identification information is out of a specified range.

### CROSS-REFERENCE TO RELATED APPLICATION

This application claims the benefit of priority to Korean Patent Application No. 10-2023-0046876, filed in the Korean Intellectual Property Office on Apr. 10, 2023, the entire contents of which are incorporated herein by reference.

### TECHNICAL FIELD

The present disclosure relates to an autonomous driving control apparatus, a system including the same, and a method thereof.

### BACKGROUND

Various technologies associated with a driving device have been developed. For example, as more pieces of data are used to control driving of the driving device to a destination, various methods for processing the data have been developed.

The driving device may be implemented as various types. For example, various driving devices, such as an autonomous vehicle, a mobile robot, and an unmanned aerial vehicle, which may be implemented such that drivers remotely perform driving control without directly controlling driving, may be implemented.

A mobile robot may be used for various purposes in various environments. For example, the mobile robot may move to a specific place (e.g., an indoor parking lot and/or an outdoor parking lot) to deliver a product. When the mobile robot has the product to move to the specific place, a user who requests to deliver the product may receive the product based on various authentication mechanisms.

For example, an autonomous driving control apparatus may obtain and/or use various types of data using its sensor device to control driving of a mobility device in the specific place. For example, the autonomous driving control apparatus may include at least one sensor which senses information about at least one vehicle which is present in the specific place. As an example, while controlling the driving of the mobility device, the autonomous driving control apparatus may perform a function of estimating a location of the mobility device using data obtained by using the sensor and identifying a location of a destination (or a target vehicle).

However, according to a type of the specific place in which the mobility device is traveling, the above-mentioned function of estimating the location of the mobility device may be degraded in accuracy. For example, an error in the result of location estimation may be relatively high in a place (e.g., an indoor parking lot and/or an outdoor parking lot) where there are relatively few feature points in data obtained by the sensor. For example, in a place (e.g., the indoor parking lot and/or the outdoor parking lot) where patterns in which locations of the mobility device are similar to each other are repeated, as there are more candidates of points estimated as locations of the mobility device, there is a problem in which a relatively high error occurs in the result of location estimation or the accuracy of the result of location estimation is degraded. Thus, the problem may be solved to some extent by mounting a sensor with high accuracy on the mobility device. However, as the production cost of mobility devices increases in such a method, it may be difficult to mass produce mobility devices.

Descriptions in this background section are provided to enhance understanding of the background of the disclosure, and may include descriptions other than those of the prior art already known to those of ordinary skill in the art to which this technology belongs.

### SUMMARY

The following summary presents a simplified summary of certain features. The summary is not an extensive overview and is not intended to identify key or critical elements.

An aspect of the present disclosure provides an autonomous driving control apparatus for allowing an autonomous driving control apparatus which controls driving of a mobility device to calibrate a sensor device using image data about a specified place, which is obtained using a sensor, and identification information about at least one vehicle in the specified place, which is received from the outside (e.g., a control server), to improve the accuracy of a positioning function used for the driving of the mobility device

An aspect of the present disclosure provides an autonomous driving control apparatus for obtaining image data about at least one vehicle in a specified place, using a sensor device mounted on one area of a mobility device and measuring performance of the sensor device or calibrating the sensor device using the obtained image data and identification information about the at least one vehicle, which is received from the outside (e.g., a control server), a system including the same, and a method thereof.

An aspect of the present disclosure provides an autonomous driving control apparatus for identifying license plate information and/or location information of each of at least one vehicle in a specified place, using at least one of the result of sensor fusion about image data obtained using a sensor device, the result of optical character recognition (OCR) for the image data, or a combination thereof, a system including the same, and a method thereof.

An aspect of the present disclosure provides an autonomous driving control apparatus for comparing location information detected (or obtained) by means of a sensor device with identification information received from a server and calibrate the sensor device using at least one of a current location of a mobility device, which is obtained using the sensor device, a relative location between at least one vehicle in a specified place and the mobility device, location information of the at least one vehicle, license plate information of the at least one vehicle, or a combination thereof, when an error calculated as a result of the comparison is out of a specified range, a system including the same, and a method thereof.

The technical problems to be solved by the present disclosure are not limited to the aforementioned problems, and any other technical problems not mentioned herein will be clearly understood from the following description by those skilled in the art to which the present disclosure pertains.

An autonomous driving control apparatus may comprise: a sensor device including at least one sensor; a memory storing instructions; and a controller operatively coupled to the sensor device and the memory, wherein the instructions are configured to, when executed by the controller, cause the autonomous driving control apparatus to: control a mobility device to move to a specified place and obtain, using the sensor device, image data of at least one vehicle in the specified place; detect, using the image data, location information of the at least one vehicle; receive identification information corresponding to the at least one vehicle; and calibrate, based on an error identified based on the location information and the identification information being out of a specified range, the sensor device using at least one of: the location information, the identification information, the error identified based on the location information and the identification information, or a combination thereof.

The at least one sensor may comprise at least one of a light detection and ranging (LiDAR) three-dimensional (3D) device, a front two-dimensional (2D) camera, a rear 2D camera, or a combination thereof.

The instructions may be configured to, when executed by the controller, cause the autonomous driving control apparatus to: identify license plate information and the location information of the at least one vehicle, using at least one of a result of sensor fusion about the image data, a result of an optical character recognition (OCR) for the image data, or a combination thereof.

The instructions may be configured to, when executed by the controller, cause the autonomous driving control apparatus to: compare the license plate information and the location information with the identification information to calculate the error.

The instructions may be configured to, when executed by the controller, cause the autonomous driving control apparatus to: perform extrinsic calibration for the at least one sensor, before controlling the mobility device to move to the specified place; and map point cloud data obtained using the sensor device to two-dimensional (2D) image data to generate the result of the sensor fusion, based on a result of performing the extrinsic calibration and an intrinsic parameter of the at least one sensor.

The identification information may comprise at least one of: a plurality of regions of interest (ROIs) respectively corresponding to a plurality of parking areas in the specified place, at least one region of interest (ROI) corresponding to a parking area where a vehicle is parked among the plurality of ROIs, an identification number of the at least one ROI, a location of each of the at least one vehicle which is parked in at least one parking area of the plurality of parking areas, a vehicle number of each of the at least one vehicle, a vehicle class of each of the at least one vehicle, coordinates of each of the at least one vehicle, a width of each of the at least one vehicle, a height of each of the at least one vehicle, or a combination thereof.

The instructions may be configured to, when executed by the controller, cause the autonomous driving control apparatus to: identify, based on the error identified based on the location information and the identification information being within the specified range, a driving path from a current location of the mobility device to a destination; and increase, based on the driving path being a straight path, a speed of the mobility device.

The instructions may be configured to, when executed by the controller, cause the autonomous driving control apparatus to: decrease, based on the error identified based on the location information and the identification information being out of the specified range, a real-time driving speed of the mobility device.

The instructions may be configured to, when executed by the controller, cause the autonomous driving control apparatus to: detect, using the sensor device, first location information and first license plate information of a first vehicle of the at least one vehicle; receive, using a communication device, first identification information of the first vehicle; and compare, based on a number included in the first identification information corresponding to the first license plate information, the first location information with location information included in the first identification information to calculate the error.

The instructions may be configured to, when executed by the controller, cause the autonomous driving control apparatus to: calibrate the sensor device by using at least one of: a current location of the mobility device, the current location being obtained using the sensor device, a relative location of the first vehicle relative to the mobility device, the first location information, the first license plate information, or a combination thereof.

An autonomous driving control system may comprise: an autonomous driving control apparatus configured to: control a mobility device to move to a specified place to obtain, using a sensor device, first image data of at least one vehicle in the specified place, detect, using the first image data, location information of the at least one vehicle, receive identification information corresponding to the at least one vehicle, and calibrate, based on an error identified based on the location information and the identification information being out of a specified range, the sensor device using at least one of the location information, the identification information, the error identified based on the location information and the identification information, or a combination thereof; and a computing device configured to: obtain second image data of the at least one vehicle using at least one camera disposed in the specified place, generate, based on the second image data, the identification information corresponding to the at least one vehicle, and transmit the identification information to the autonomous driving control apparatus.

The computing device may be configured to: set a plurality of regions of interest (ROIs) respectively corresponding to a plurality of parking areas in the specified place; and obtain, using the at least one camera, the second image data including the plurality of ROIs.

The computing device may be configured to: perform an optical character recognition (OCR) for at least one region of interest (ROI) corresponding to a parking area where the at least one vehicle is parked among the plurality of ROIs to identify a vehicle number of the at least one vehicle.

The computing device may be configured to: update, based on a specified period, the identification information corresponding to the at least one vehicle in the specified place.

The identification information may comprise at least one of: the plurality of ROIs respectively corresponding to the plurality of parking areas, at least one region of interest (ROI) corresponding to a parking area where a vehicle is parked among the plurality of ROIs, an identification number of the at least one ROI, a location of each of the at least one vehicle parked in at least one parking area of the plurality of parking areas, a vehicle number of each of the at least one vehicle, a vehicle class of each of the at least one vehicle, coordinates of each of the at least one vehicle, a width of each of the at least one vehicle, a height of each of the at least one vehicle, or a combination thereof.

An autonomous driving control method may comprise: controlling, by a controller, a mobility device to move to a specified place; obtaining, by the controller and using a sensor device, image data of at least one vehicle in the specified place; detecting, by the controller and using the image data, location information of the at least one vehicle; receiving identification information corresponding to the at least one vehicle; and calibrating, by the controller and based on an error identified based on the location information and the identification information being out of a specified range, the sensor device using at least one of: the location information, the identification information, the error identified based on the location information and the identification information, or a combination thereof.

The sensor device may comprise at least one of a three-dimensional (3D) light detection and ranging (LiDAR) device, a front two-dimensional (2D) camera, a rear 2D camera, or a combination thereof.

The detecting of the location information may comprise: identifying, by the controller, license plate information and the location information of the at least one vehicle, using at least one of a result of sensor fusion about the image data, a result of an optical character recognition (OCR) for the image data, or a combination thereof.

The calibrating of the sensor device may comprise: comparing, by the controller, the license plate information and the location information with the identification information to calculate the error.

The method may further comprise: performing, by the controller, extrinsic calibration for at least one sensor of the sensor device, before controlling the mobility device to move to the specified place; and mapping, by the controller, point cloud data obtained using the sensor device to two-dimensional (2D) image data to generate the result of the sensor fusion, based on a result of performing the extrinsic calibration and an intrinsic parameter of the at least one sensor.

These and other features and advantages are described in greater detail below.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating components of an autonomous driving control system;

FIG. 2 is a diagram illustrating a situation where an autonomous driving control apparatus and a control server collect data about at least one vehicle in a specified place;

FIG. 3 is a diagram illustrating a situation where an autonomous driving control apparatus and a control server collect data about at least one vehicle in a specified place;

FIG. 4 illustrates an example of identification information about at least one vehicle parked in a specified place;

FIG. 5 illustrates an identification information about at least one vehicle parked in a specified place;

FIG. 6 is a diagram illustrating a situation where an autonomous driving control apparatus and a control server collect data about at least one vehicle in a specified place;

FIG. 7 is a diagram of an operation where an autonomous driving control apparatus performs a positioning operation;

FIG. 8 is an operational flowchart of an autonomous driving control apparatus;

FIG. 9 is an operational flowchart of an autonomous driving control apparatus; and

FIG. 10 illustrates a computing system for performing an autonomous driving control method.

With regard to description of drawings, the same or similar denotations may be used for the same or similar components.

### DETAILED DESCRIPTION

Hereinafter, various examples of the present disclosure will be described in detail with reference to the exemplary drawings. In the drawings, the same reference numerals will be used throughout to designate the same or equivalent elements. In addition, a detailed description of well-known features or functions may be omitted in order not to unnecessarily obscure the gist of the present disclosure.

In describing the components of the present disclosure, terms such as first, second, “A”, “B”, (a), (b), and the like may be used. These terms are only used to distinguish one element from another element, but do not limit the corresponding elements irrespective of the order or priority of the corresponding elements. Furthermore, unless otherwise defined, all terms including technical and scientific terms used herein are to be interpreted as is customary in the art to which this disclosure pertains. It will be understood that terms used herein should be interpreted as having a meaning that is consistent with their meaning in the context of this disclosure and the relevant art and will not be interpreted in an idealized or overly formal sense unless expressly so defined herein.

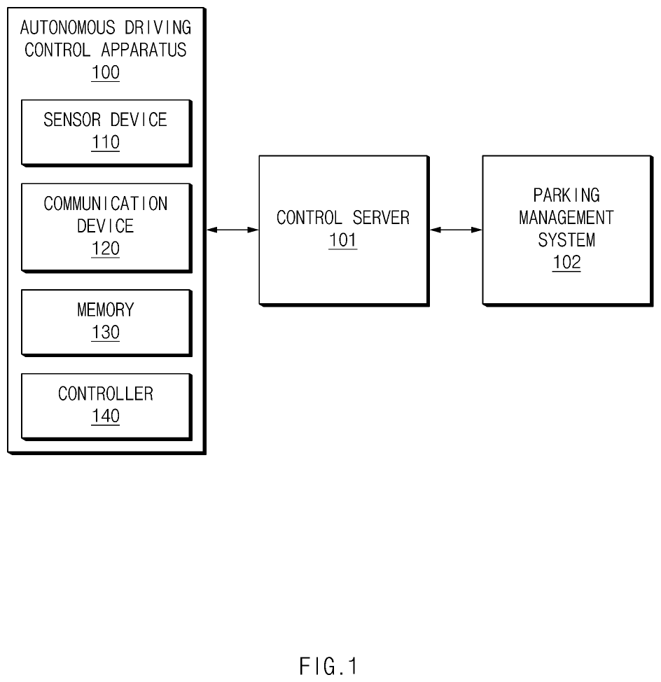

Hereinafter, various examples of the present disclosure will be described in detail with reference to FIGS. 1 to 10.

FIG. 1 is a block diagram illustrating components of an autonomous driving control system.

With regard to description of drawings, the same or similar denotations may be used for the same or similar components.

An autonomous driving control apparatus 100 may include at least one of a sensor device 110, a communication device 120, a memory 130, a controller 140, or a combination thereof. The components of the autonomous driving control apparatus 100 (e.g., shown in FIG. 1) are illustrative, and aspects of the present disclosure are not limited thereto. For example, the autonomous driving control apparatus 100 may include a component which is not shown in FIG. 1. For example, at least some of the components of the autonomous driving control apparatus 100, which are shown in FIG. 1, may be implemented as a part of the controller 140. For example, at least some (e.g., the sensor device 110) of the components included in the autonomous driving control apparatus 100 may be arranged in at least one area of a mobility device which performs autonomous driving under control of the autonomous driving control apparatus 100.

The autonomous driving control apparatus 100 may control a mobility device (e.g., a mobile robot), using at least some of the above-mentioned components.

The sensor device 110 may obtain (or sense) various pieces of information used for driving of the mobility device.

For example, the sensor device 110 may include at least one sensor which is disposed in at least one area of the mobility device to obtain various pieces of information about the periphery of the mobility device. As an example, the at least one sensor may include at least one of a three-dimensional (3D) light detection and ranging (LiDAR), a front two-dimensional (2D) camera, a rear 2D camera, or a combination thereof.

For example, the sensor device 110 may obtain image data using the at least one sensor.

For example, the sensor device 110 may obtain information about an external object (e.g., at least one of a person, another vehicle, a building, a structure, or a combination thereof), using the at least one sensor.

For example, the sensor device 110 may obtain image data about an area adjacent to the mobility device. As an example, when the mobility device is present in a specified place (e.g., an indoor parking lot and/or an outdoor parking lot), the sensor device 110 may obtain image data about at least one vehicle in the specified place.

The communication device 120 may establish a communication channel (e.g., a wireless communication channel) between the autonomous driving control apparatus 100 and an external device (e.g., a control server 101) and may assist in communicating over the established communication channel. For example, the communication device 120 may include one or more communication processors which operate independently of the controller 140 (e.g., an application processor) and support direct (e.g., wired) communication or wireless communication.

For example, the communication device 120 may include a wireless communication module (e.g., a cellular communication module, a short range wireless communication module, or a global navigation satellite system (GNSS) communication module) or a wired communication module (e.g., a local area network (LAN) communication module or a power line communication module). The corresponding communication module among such communication modules may communicate with the external device over a first network (e.g., a short range communication network such as Bluetooth, wireless-fidelity (Wi-Fi) Direct, or infrared data association (IrDA)) or a second network (e.g., a long range communication network such as a legacy cellular network, a fifth generation (5G) network, a next-generation communication network, the Internet, or a computer network (e.g., a local area network (LAN) or a wide area network (WAN))). Such several types of communication modules may be integrated into one component (e.g., a single chip) or may be implemented as a plurality of components (e.g., a plurality of chips) independent of each other. Furthermore, the communication device 120 and the controller 140 may be implemented as a single chip.

For example, the communication device 120 may transmit and receive various pieces of data based on communication with the external device.

As an example, the communication device 120 may receive identification information corresponding to each of at least one vehicle in the specified place from the external device. The identification information may include, for example, information about each of at least one vehicle, which may be obtained using some (e.g., at least one camera) of components of a parking management system 102 by the control server 101. The identification information may include at least one of, for example, a plurality of regions of interest (ROIs) respectively corresponding to a plurality of parking areas in the specified place, at least one ROI corresponding to a parking area where at least one vehicle is parked among the plurality of ROIs, an identification number of the at least one ROI, a location of each of at least one vehicle which is parking in some of the plurality of parking areas, a vehicle number of each of the at least one vehicle, a vehicle class of each of the at least one vehicle, coordinates of each of the at least one vehicle, a width of each of the at least one vehicle, a height of each of the at least one vehicle, or a combination thereof.

The memory 130 may store a command or data. For example, the memory 130 may store one or more instructions, when executed by the controller 140, causing the autonomous driving control apparatus 100 to perform various operations.

For example, the memory 130 and the controller 140 may be implemented as one chipset. The controller 140 may include at least one of a communication processor or a modem.

For example, the memory 130 may store various pieces of information associated with the autonomous driving control apparatus 100. As an example, the memory 130 may store information about an operation history of the controller 140. As an example, the memory 130 may store pieces of information associated with states and/or operations of components (e.g., a driving device (or a motor)) of the mobility device (or the mobile robot) controlled by the autonomous driving control apparatus 100 and/or components (e.g., at least one of the sensor device 110, the communication device 120, or a combination thereof) of the autonomous driving control apparatus 100.

The controller 140 may be operatively connected with at least one of the sensor device 110, the communication device 120, the memory 130, or a combination thereof. For example, the controller 140 may control an operation of at least one of the sensor device 110, the communication device 120, the memory 130, or a combination thereof.

For example, the controller 140 may control the mobility device to the specified place. As an example, the specified place may be an indoor parking lot or an outdoor parking lot where the mobility device (e.g., a target vehicle) is parked.

For example, before controlling the mobility device to the specified place, the controller 140 may perform extrinsic calibration for at least one sensor. An example, the controller 140 may store the result of performing the extrinsic calibration in the memory 130 and may use it to generate a result of sensor fusion in the future.

For example, after controlling the mobility device to the specified place, the controller 140 may obtain image data about at least one vehicle in the specified place using the sensor device 110. As an example, the controller 140 may detect first location information and first license plate information of a first vehicle included in the at least one vehicle in the specified place, based on various processing methods (e.g., optical character recognition (OCR)) for the image data obtained using the sensor device 110. The first vehicle may be, for example, a vehicle parked in at least one of the plurality of parking areas in the specified place. The controller 140 may repeatedly perform, for example, the above-mentioned image data processing and may detect location information and license plate information about each of the at least one vehicle parked in the specified place.

For example, the controller 140 may identify (or detect) location information about each of the at least one vehicle using the image data. As an example, the controller 140 may identify (or detect) license plate information and the location information of each of the at least one vehicle, using at least one of the result of sensor fusion about the image data, the result of OCR for the image data, or a combination thereof. As an example, the controller 140 may map point cloud data obtained using the sensor device 110 to 2D image data. The mapping the point cloud data may be to generate the result of sensor fusion, based on the result of performing extrinsic calibration for the at least one sensor, which may be performed before moving the mobility device to the specified place, and an intrinsic parameter of the at least one sensor. The controller 140 may identify (or detect) license plate information and the location information of each of the at least one vehicle, using at least one of the generated result of the sensor fusion, the result of the OCR for the image data, or a combination thereof.

For example, the controller 140 may receive identification information corresponding to each of the at least one vehicle in the specified place from the control server 101, using the communication device 120. As an example, the identification information may include information about each of the at least one vehicle, which may be obtained using some (e.g., at least one camera) of the components of the parking management system 102 by the control server 101. The identification information may include at least one of, for example, a plurality of regions of interest (ROIs) respectively corresponding to a plurality of parking areas in the specified place, at least one ROI corresponding to a parking area where at least one vehicle is parked among the plurality of ROIs, an identification number of the at least one ROI, a location of each of at least one vehicle which is parking in some of the plurality of parking areas, a vehicle number of each of the at least one vehicle, a vehicle class of each of the at least one vehicle, coordinates of each of the at least one vehicle, a width of each of the at least one vehicle, a height of each of the at least one vehicle, or a combination thereof.

For example, the controller 140 may identify (or determine) whether an error between the location information and the identification information is out of a specified range. As an example, the controller 140 may compare the license plate information and the location information of each of the at least one vehicle, which are identified using at least one of the result of the sensor fusion about the image data, the result of the OCR for the image data, or the combination thereof, with the identification information received from the control server 101 to calculate the error. As an example, the controller 140 may detect the first location information and the first license plate information of the first vehicle included in the at least one vehicle using the sensor device 110, may receive identification information including first identification information corresponding to the first vehicle using the communication device 120, and may determine whether a number included in the first identification information corresponds to the first license plate information. If the number included in the first identification information corresponds to the first license plate information, the controller 140 may compare the first location information with a location of the first vehicle, which may be included in the first identification information, to calculate the error. The controller 140 may repeatedly perform, for example, the above-mentioned error calculation process for each of the at least one vehicle to calculate a final error.

For example, the controller 140 may distinguish the case where the error is out of the specified range from the case where the error is within the specified range and may perform autonomous driving control for the mobility device in different manners.

As an example, if the error between the location information and/or the license plate information and the identification information is out of the specified range, the controller 140 may calibrate the sensor device 110 using any one of the location information, the license plate information, the identification information, the error, or a combination thereof. For example, if it is determined that the error is out of the specified range, the controller 140 may calibrate the sensor device 110, using at least one of a current location of the mobility device, which is obtained using the sensor device 110, a relative location between at least some of the at least one vehicle parked in the specified place and the mobility device, location information of each of the at least one vehicle, license plate information of each of the at least one vehicle, or a combination thereof. In this case, the controller 140 may reduce a real-time driving speed of the mobility device.

As an example, if the error between the location information and/or the license plate information and the identification information is within the specified range, the controller 140 may increase a drivable speed limit of the mobility device. For example, if the error is within the specified range, the controller 140 may determine that positioning performance of the sensor device 110 is normal and may increase a drivable maximum speed of the mobility device. As an example, only when a straight path is included in a driving path from the current location of the mobility device to the destination, the controller 140 may increase the drivable maximum speed. In other words, on the premise that an expected driving path which should be driven to the destination is a straight path with respect to the current location of the mobility device, when the error is within the specified range, the controller 140 may increase the drivable maximum speed of the mobility device.

The control server 101 may communicate with the autonomous driving control apparatus 100 and/or the parking management system 102. For example, the control server 101 may transmit and receive various pieces of data about the specified place (e.g., the indoor parking lot or the outdoor parking lot) with the autonomous driving control apparatus 100 and/or the parking management system 102.

For example, the control server 101 may receive image data including information about each of the at least one vehicle in the specified place from the parking management system 102. As an example, the control server 101 may control at least one camera included in the parking management system 102 to obtain and receive the image data including the information about each of the at least one vehicle. The at least one camera may include, for example, cameras respectively installed in the plurality of areas in the specified place.

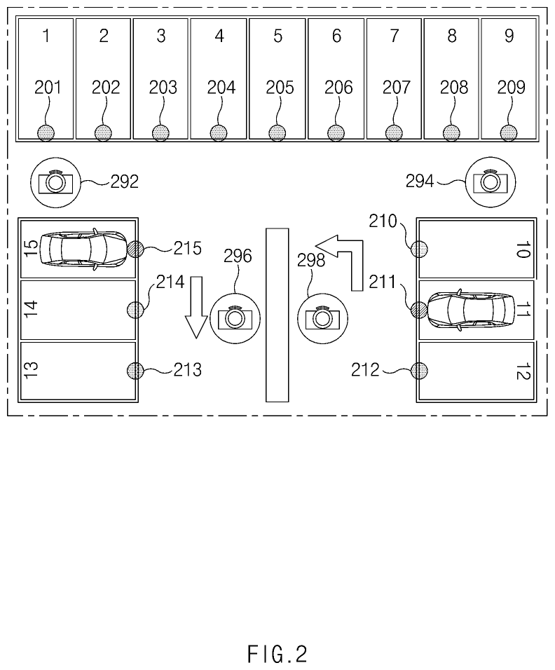

For example, the control server 101 may set a plurality of regions of interest (ROIs) respectively corresponding to the plurality of parking areas in the specified place. As an example, the control server 101 may obtain image data including the plurality of ROIs, using at least one camera included in the parking management system 102. A description will be given in detail below for the plurality of ROIs with reference to FIG. 2.

For example, the control server 101 may generate identification information corresponding to each of the at least one vehicle based on the image data obtained using the at least one camera and may transmit the generated identification information to the autonomous driving control apparatus 100. As an example, the control server 101 may perform optical character recognition (OCR) for at least one ROI corresponding to a parking area where the at least one vehicle is parked among the plurality of ROIs to identify a vehicle number of the at least one vehicle. As an example, the control server 101 may update identification information about the at least one vehicle in the specified place, based on a specified period. As an example, the control server 101 may transmit the updated identification information to the autonomous driving control apparatus 100 (e.g., on a periodic basis).

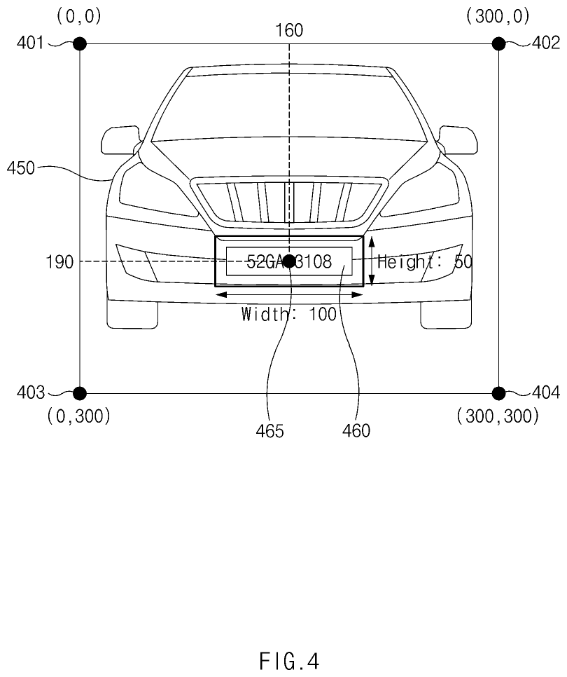

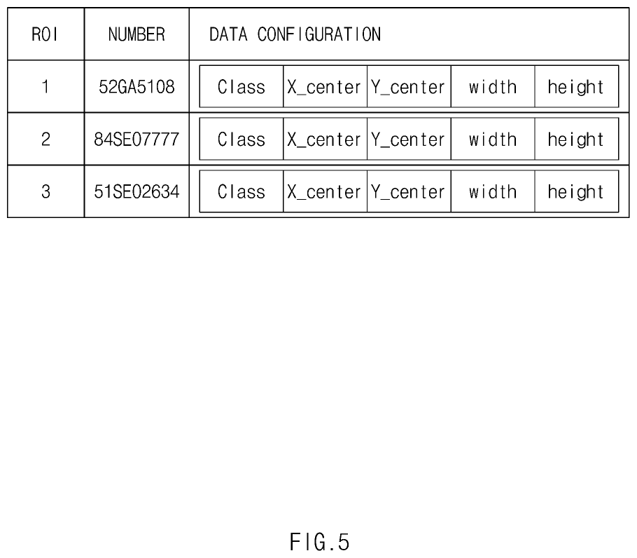

The identification information may include at least one of the plurality of ROIs respectively corresponding to the plurality of parking areas, at least one ROI corresponding to a parking area where at least one vehicle is parked among the plurality of ROIs, an identification number of the at least one ROI, a location of each of the at least one vehicle parked in the parking area, a vehicle number of each of the at least one vehicle, a vehicle class of each of the at least one vehicle, coordinates of each of the at least one vehicle, a width of each of the at least one vehicle, a height of each of the at least one vehicle, or a combination thereof. A description will be given in detail below for the identification information reference to FIGS. 4 and 5.

FIG. 2 is a diagram illustrating a situation where an autonomous driving control apparatus and a control server collect data about at least one vehicle in a specified place.

An autonomous driving control apparatus (e.g., an autonomous driving control apparatus 100 of FIG. 1) and a control server (e.g., a control server 101 of FIG. 1) may collect data about each of at least one vehicle in a specified place.

For example, after controlling a mobility device to a specified place shown in FIG. 2, while moving the mobility device using a sensor device (e.g., a sensor device 110 of FIG. 1) mounted on one area of the mobility device, the autonomous driving control apparatus may obtain first image data for at least one vehicle which is present within a sensing coverage of at least one sensor of the sensor device.

For example, the control server may obtain second image data about the at least one vehicle in the specified place using at least one camera 292, 294, 296, and 298 arranged on one area of the specified place shown in FIG. 2. As an example, the at least one camera 292, 294, 296, and 298 may be one component of a parking management system (e.g., a parking management system 102 of FIG. 1) which communicates with the control server. As an example, the parking management system including the at least one camera 292, 294, 296, and 298 may be implemented as a part of the control server.

For example, the control server may set a plurality of regions of interest (ROIs) 201 to 215 respectively corresponding to a plurality of parking areas in the specified place.

As an example, the control server may separately set the first ROI 201 corresponding to a first parking area, the second ROI 202 corresponding to a second parking area, the third ROI 203 corresponding to a third parking area, the fourth ROI 204 corresponding to a fourth parking area, the fifth ROI 205 corresponding to a fifth parking area, the sixth ROI 206 corresponding to a sixth parking area, the seventh ROI 207 corresponding to a seventh parking area, the eighth ROI 208 corresponding to an eighth parking area, the ninth ROI 209 corresponding to a ninth parking area, the tenth ROI 210 corresponding to a tenth parking area, the eleventh ROI 211 corresponding to an eleventh parking area, the twelfth ROI 212 corresponding to a twelfth parking area, the thirteenth ROI 213 corresponding to a thirteenth parking area, the fourteenth ROI 214 corresponding to a fourteenth parking area, and/or the fifteenth ROI 215 corresponding to a fifteenth parking area.

As an example, the control server may obtain the second image data including the plurality of ROIs 201 to 215, using at least some of the at least one camera 292, 294, 296, and 298.

As an example, the control server may divide the plurality of ROIs 201 to 215 respectively corresponding to the plurality of parking areas into a plurality of groups and may control the at least one camera 292, 294, 296, and 298 to obtain image data including an ROI included in each of the plurality of groups using the first camera 292 among the at least one camera 292, 294, 296, and 298. For example, the control server may obtain image data including the first to fifth ROIs 201 to 205 using the first camera 292. For example, the control server may obtain image data including the sixth to ninth ROIs 206 to 209 using the second camera 294. For example, the control server may obtain image data including the thirteenth to fifteenth ROIs 213 to 215 using the third camera 296. For example, the control server may obtain image data including the tenth to twelfth ROIs 210 to 212 using the fourth camera 298. The control server may merge the image data obtained using the at least one camera 292, 294, 296, and 298 to obtain the second image data including the plurality of ROIs 201 to 215.

For example, the control server may identify a vehicle parked in the fifteenth parking area corresponding to the fifteenth ROI 215, based on the image data obtained using the third camera 296. The control server may generate identification information of the vehicle parked in the fifteenth parking area, using the image data obtained using the third camera 296.

For example, the control server may identify a vehicle parked in the eleventh parking area corresponding to the eleventh ROI 211, based on the image data obtained using the fourth camera 298. The control server may generate identification information of the vehicle parked in the eleventh parking area, using the image data obtained using the fourth camera 298.

For example, the identification information may include at least one of a plurality of ROIs (e.g., the first to fifteenth ROIs 201 to 215) respectively corresponding to the plurality of parking areas (e.g., the first to fifteenth parking areas), at least one ROI (e.g., the eleventh ROI 211 and the fifteenth ROI 215) corresponding to a parking area (e.g., the eleventh parking area and the fifteenth parking area) where at least one vehicle is parked among the plurality of ROIs 201 to 215, an identification number (e.g., 11 and 15) of the at least one ROI, a location of each of the at least one vehicle parked in the parking area, a vehicle number of each of the at least one vehicle, a vehicle class of each of the at least one vehicle, coordinates of each of the at least one vehicle, a width of each of the at least one vehicle, a height of each of the at least one vehicle, or a combination thereof.

For example, the control server may transmit the identification information generated in response to each of the at least one vehicle parked in the eleventh and fifteenth parking areas to the autonomous driving control apparatus.

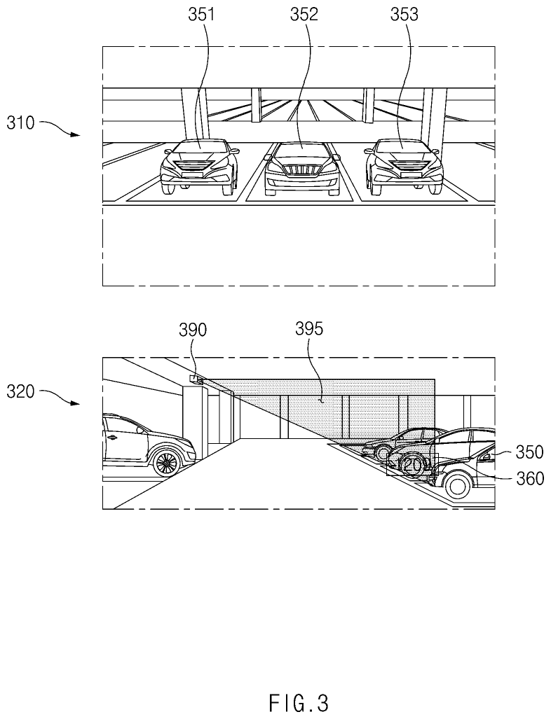

FIG. 3 is a diagram illustrating a situation where an autonomous driving control apparatus and a control server collect data about at least one vehicle in a specified place.

Referring to reference numeral 310, an autonomous driving control apparatus (e.g., an autonomous driving control apparatus 100 of FIG. 1) may obtain image data about at least one vehicle which is present in a specified place (e.g., an indoor parking lot or an outdoor parking lot) using a sensor device (e.g., a sensor device 110 of FIG. 1) and identify (or detect) license plate information and/or location information of each of the at least one vehicle using the image data.

For example, reference numeral 310 may be an example of image data using the sensor device mounted on a part of a mobility device by the autonomous driving control apparatus. While controlling autonomous driving of the mobility device through an area of the specified place shown in reference numeral 310, the autonomous driving control apparatus may obtain image data using the sensor device mounted on the part of the mobility device and may identify license plate information and/or location information about each of a first vehicle 351, a second vehicle 352, and/or a third vehicle 353 included in the image data.

Referring to reference numeral 320, a control server (e.g., a control server 101 of FIG. 1) may obtain image data about at least one vehicle which is present in a specified place using at least one camera (e.g., at least one camera 292, 294, 296, and 298 of FIG. 2) disposed in the specified place and may generate identification information corresponding to each of the at least one vehicle using the image data to transmit the identification information to the autonomous driving control apparatus.

For example, referring to reference numeral 320, the control server may generate identification information about at least one vehicle including fourth identification information corresponding to a fourth using a camera 390 disposed in an area in the specified place and may transmit the identification information to the autonomous driving control apparatus. As an example, the fourth identification information may include the result of OCR performed for a license plate 360 of the fourth vehicle 350 included in the image data obtained using the camera 390. As an example, because the camera 390 has a specified sensing coverage 395, the control server may generate identification information by further using one or more other cameras except for the camera 390.

FIG. 4 illustrates an example of identification information about at least one vehicle parked in a specified place.

An autonomous driving control apparatus (e.g., an autonomous driving control apparatus 100 of FIG. 1) and a control server (e.g., a control server 101 of FIG. 1) may generate (or detect) license plate information, location information, and/or identification information about a vehicle 460 shown in FIG. 4.

For example, the identification information may include at least one of a plurality of ROIs respectively corresponding to a plurality of parking areas, at least one ROI corresponding to a parking area where at least one vehicle is parked among the plurality of ROIs, an identification number of the at least one ROI, a location of each of the at least one vehicle parked in the parking area, a vehicle number of each of the at least one vehicle, a vehicle class of each of the at least one vehicle, coordinates of each of the at least one vehicle, a width of each of the at least one vehicle, a height of each of the at least one vehicle, or a combination thereof.

As an example, the identification information may include the plurality of ROIs respectively corresponding to the plurality of parking areas in the specified place including a parking area where the vehicle 460 is parked. The plurality of ROIs may be a plurality of regions which are divided by the control server and are provided to respectively correspond to the plurality of parking areas.

As an example, the identification information may include at least one ROI (e.g., an eleventh ROI 211 and a fifteenth ROI 215 of FIG. 2) corresponding to a parking area (e.g., an eleventh area and a fifteenth area of FIG. 2) where at least one vehicle is parked among the plurality of ROIs and an identification number (e.g., 11 and 15 of FIG. 2) of the at least one ROI.

As an example, the identification information may include a location of each of the at least one vehicle parked in the parking area. For example, the control server may include a location where the vehicle 460 is identified in the identification information.

As an example, the identification information may include a vehicle number and a vehicle class. The control server may perform, for example, processing for the image data including the vehicle 460 and may include the identified vehicle class (e.g., a vehicle type) and a vehicle number identified through a license plate of the vehicle 460 in the identification information.

As an example, the identification information may include coordinates of a center point 465 of the vehicle 460, which may be calculated on the basis of a first point 401, a second point 402, a third point 403, and a fourth point 404 of an ROI including the vehicle 460 (e.g. a box including the vehicle 460 shown in FIG. 4). As an example, an x-coordinate and a y-coordinate of the center point 465 of the vehicle 460 according to an example of FIG. 4 may be 160 and 190, respectively.

As an example, the identification information may include information about a width of the vehicle 460 according to the example of FIG. 4 and/or a width (e.g., 100 cm or any other length) of a license plate of the vehicle 460.

As an example, the identification information may include information about a height of the vehicle 460 according to the example of FIG. 4 and/or a height (e.g., 50 cm or any other length) of the license plate of the vehicle 460.

FIG. 5 illustrates an example of identification information about at least one vehicle parked in a specified place.

The identification information may include at least one of a plurality of ROIs respectively corresponding to a plurality of parking areas, at least one ROI corresponding to a parking area where at least one vehicle is parked among the plurality of ROIs, an identification number of the at least one ROI, a location of each of the at least one vehicle parked in the parking area, a vehicle number of each of the at least one vehicle, a vehicle class of each of the at least one vehicle, coordinates of each of the at least one vehicle, a width of each of the at least one vehicle, a height of each of the at least one vehicle, or a combination thereof.

Referring to FIG. 5, the identification information may include vehicle numbers of vehicles respectively parked in three ROIs and pieces of data about the vehicles.

For example, the identification information may include information that the vehicle is parked in the ROI where the identification number is NO. 1. As an example, a vehicle number of the vehicle parked in the ROI where the identification number is NO. 1 may be 52Ga5108. As an example, information about a vehicle class Class of the vehicle parked in the ROI where the identification number is NO. 1, an x-coordinate X_center and a y-coordinate Y_center of a center point of the vehicle, a width of the vehicle, and a height of the vehicle may be included as a data configuration included in identification information in the identification information.

For example, the identification information may include information that the vehicle is parked in the ROI where the identification number is NO. 2. As an example, a vehicle number of the vehicle parked in the ROI where the identification number is NO. 2 may be 84Seo7777. As an example, information about a vehicle class Class of the vehicle parked in the ROI where the identification number is NO. 2, an x-coordinate X_center and a y-coordinate Y_center of a center point of the vehicle, a width of the vehicle, and a height of the vehicle may be included as in a data configuration included identification information in the identification information.

For example, the identification information may include information that the vehicle is parked in the ROI where the identification number is NO. 3. As an example, a vehicle number of the vehicle parked in the ROI where the identification number is NO. 3 may be 51Seo2634. As an example, information about a vehicle class Class of the vehicle parked in the ROI where the identification number is NO. 3, an x-coordinate X_center and a y-coordinate Y_center of a center point of the vehicle, a width of the vehicle, and a height of the vehicle may be included as a data configuration included in identification information in the identification information.

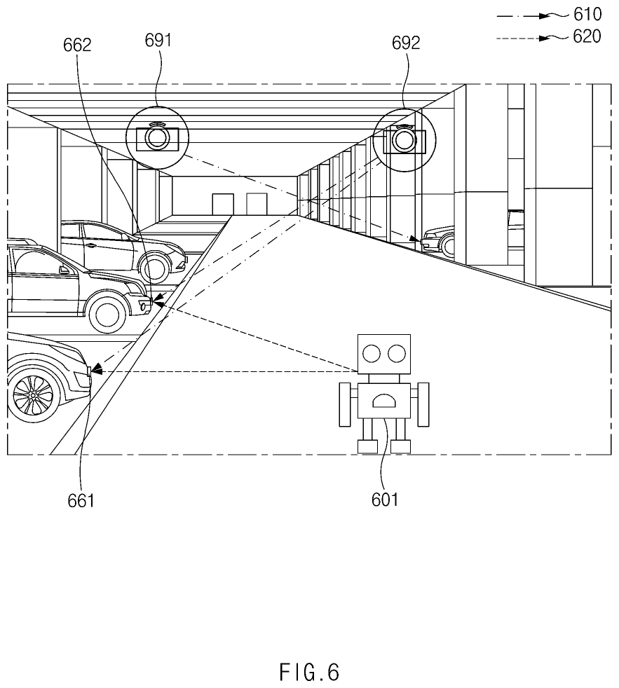

FIG. 6 is a diagram illustrating a situation where an autonomous driving control apparatus and a control server collect data about at least one vehicle in a specified place.

An autonomous driving control apparatus (e.g., an autonomous driving control apparatus 100 of FIG. 1) may obtain image data about at least one vehicle which is present in a specified place (e.g., an indoor parking lot or an outdoor parking lot) using a sensor device (e.g., a sensor device 110 of FIG. 1) and may identify (or detect) license plate information and/or location information of each of the at least one vehicle using the image data. For example, signal flow of the license plate information and/or location information obtained by the autonomous driving control apparatus may be referred to as reference numeral 610. For example, signal flow of the identification information obtained by the control server may be referred to as reference numeral 620.

For example, the autonomous driving control apparatus may obtain image data associated with a first vehicle 661 and a second vehicle 662 using the sensor device mounted on a part of the mobility device 601. While controlling autonomous driving of a mobility device 601 through one area of the specified place shown in FIG. 6, the autonomous driving control apparatus may obtain image data using the sensor device mounted on the part of the mobility device 601 and may identify license plate information and/or location information about each of the first vehicle 661 and the second vehicle 662 included in the image data.

A control server (e.g., a control server 101 of FIG. 1) may obtain image data about at least one vehicle which is present in the specified place using at least one camera 691 and 692 (e.g., at least one camera 292, 294, 296, and 298 of FIG. 2) disposed in the specified place and may generate identification information corresponding to each of the at least one vehicle using the image data to transmit the identification information to the autonomous driving control apparatus.

For example, the control server may generate identification information of the first vehicle 661 and the second vehicle 662 using the first camera 691 and the second camera 692 arranged on locations in the specified place and may transmit the identification information to the autonomous driving control apparatus. As an example, the identification information may include the result of OCR performed for a license plate of each of the first vehicle 661 and the second vehicle 662 included in the image data obtained using the first camera 691 and/or the second camera 692. As an example, because the first camera 691 and the second camera 692 have specified sensing coverages, the control server may generate identification information by further using one or more other cameras except for the shown cameras 691 and 692.

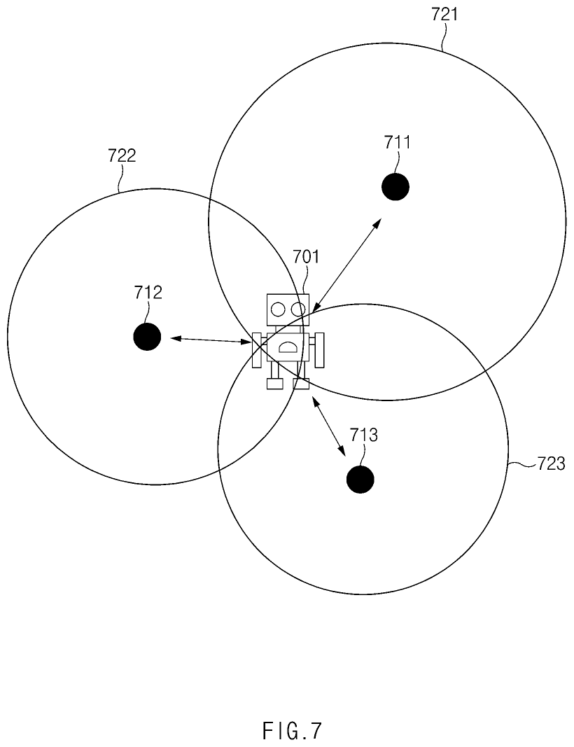

FIG. 7 is a diagram of an operation where an autonomous driving control apparatus performs a positioning operation.

An autonomous driving control apparatus (e.g., an autonomous driving control apparatus 100 of FIG. 1) may identify a relative location between a current location of a mobility device 701 and at least one ROI 711, 712, and 713 (or a vehicle parked in a parking area corresponding to the at least one ROI).

For example, the autonomous driving control apparatus may identify at least one circle 721, 722, and 723 where a separation distance between the mobility device 701 and each of the first ROI 711, the second ROI 712, and the third ROI 713 is a radius.

For example, the autonomous driving control apparatus may identify a location of the mobility device 701 using the identified at least one circle 721, 722, and 723.

For example, if an error between license plate information and/or location information obtained using a sensor device and identification information received from a control server is out of a specified range, the autonomous driving control apparatus may calibrate the sensor device, using at least one of a current location of the mobility device 701, which is obtained using the sensor device, a relative location between the mobility device 701 and the at least one ROI 711, 712, and 713 (or the vehicle parked in the parking area corresponding to the at least one ROI), location information of the at least one vehicle, license plate information of the at least one vehicle, or a combination thereof.

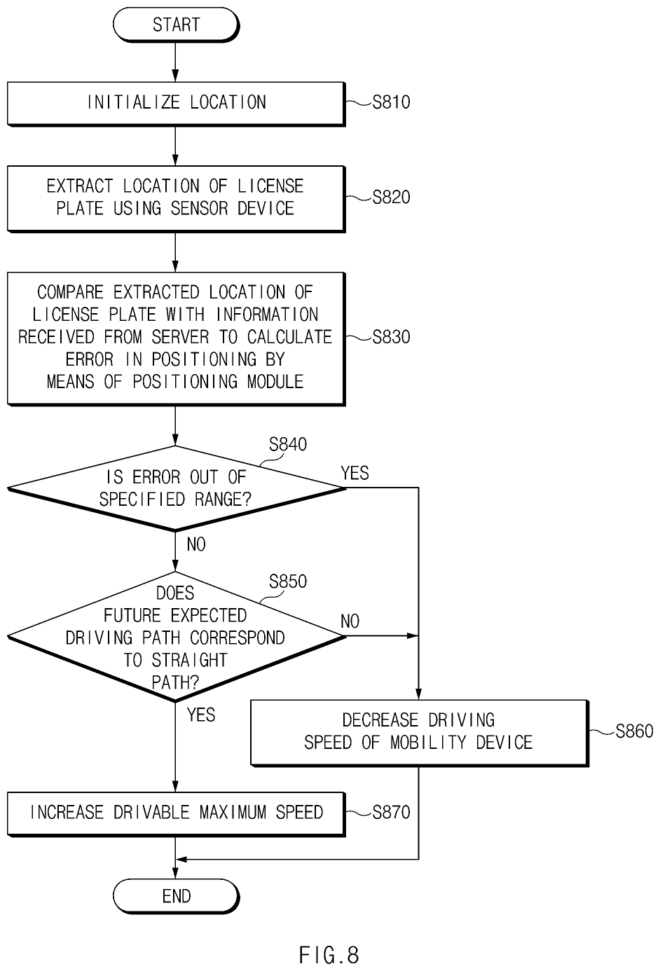

FIG. 8 is an operational flowchart of an autonomous driving control apparatus.

An autonomous driving control apparatus (e.g., an autonomous driving control apparatus 100 of FIG. 1) may perform operations disclosed in FIG. 8. For example, at least some of components (e.g., a sensor device 110 of FIG. 1, a communication device 120 of FIG. 1, a memory 130 of FIG. 1, a controller 140 of FIG. 1, or a combination thereof) included in the autonomous driving control apparatus may be configured to perform the operations of FIG. 8.

Operations in S810 to S870 may be sequentially performed, but the operations may not be sequentially performed in at least some implementations. For example, an order of the respective operations may be changed, and at least two operations may be performed in parallel. Furthermore, contents, which correspond to or are duplicated with the contents described above in conjunction with FIG. 8, may be briefly described or omitted.

In S810, the autonomous driving control apparatus may initialize a location of a mobility device.

For example, the autonomous driving control apparatus may initialize location information of the mobility device to operate a sensor for autonomous driving control of the mobility device.

In S820, the autonomous driving control apparatus may extract a location of a license plate using a sensor device.

For example, the autonomous driving control apparatus may obtain image data, using the sensor device including at least one sensor mounted on the mobility device and may extract license plate information of a license plate which is present in the obtained image data and/or location information of the license plate.

In S830, the autonomous driving control apparatus may compare the extracted location of the license plate with information received from a server to calculate an error in positioning by using a positioning module.

For example, the autonomous driving control apparatus may compare location information and/or license plate information about each of at least one vehicle, which are/is generated based on the image data obtained using the sensor device, with information (e.g., identification information of FIG. 5) received from a control server (e.g., a control server 101 of FIG. 1) to calculate an error in positioning by using the positioning module (e.g., the sensor device).

In S840, the autonomous driving control apparatus may determine whether the error is out of a specified range.

For example, if the error is out of the specified range (e.g., S840—YES), the autonomous driving control apparatus may perform operation S860.

For example, if the error is within the specified range (e.g., S840—NO), the autonomous driving control apparatus may perform operation S850.

In S850, the autonomous driving control apparatus may identify whether a future expected driving path of the mobility device corresponds to a straight path.

For example, if the future expected driving path of the mobility device corresponds to the straight path (S850—YES), the autonomous driving control apparatus may perform operation S870.

In S870, the autonomous driving control apparatus may increase a drivable maximum speed of the mobility device.

For example, if it is identified that an expected driving path scheduled for the mobility device to travel to its destination includes only a straight path, the autonomous driving control apparatus may increase the drivable maximum speed of the mobility device, thus providing more quickly and safely autonomous driving function.

For example, if the future expected driving path of the mobility device does not correspond to the straight path (S850—NO) (e.g., when the expected driving path is a curved path), the autonomous driving control apparatus may perform the operation S860.

In S860, the autonomous driving control apparatus may decrease a driving speed of the mobility device.

For example, if the error is out of the specified range, the autonomous driving control apparatus may determine that there is an error in a positioning function of the sensor device and may decrease the driving speed of the mobility device, thus providing a safe autonomous driving function.

For example, although the error is within the specified range, when the future expected driving path of the mobility device is not the straight path, the autonomous driving control apparatus may decrease the driving speed of the mobility device, thus providing a safe autonomous driving function.

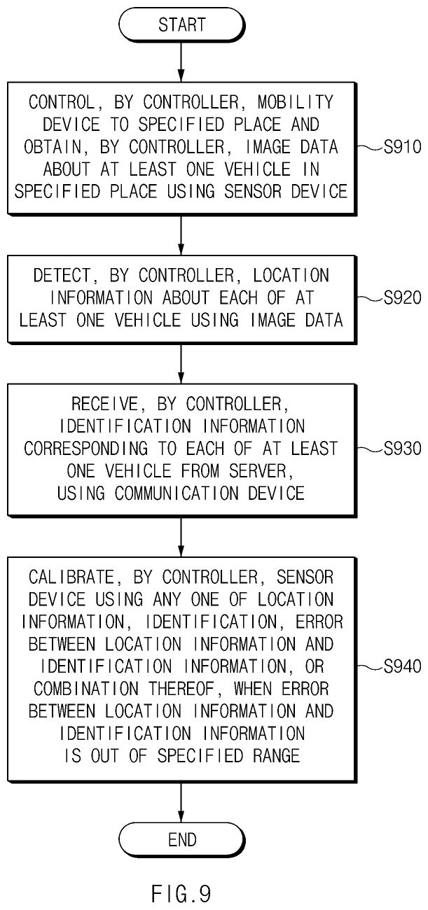

FIG. 9 is an operational flowchart of an autonomous driving control apparatus.

An autonomous driving control apparatus (e.g., an autonomous driving control apparatus 100 of FIG. 1) may perform operations disclosed in FIG. 9. For example, at least some of components (e.g., a sensor device 110 of FIG. 1, a communication device 120 of FIG. 1, a memory 130 of FIG. 1, a controller 140 of FIG. 1, or a combination thereof) included in the autonomous driving control apparatus may be configured to perform the operations of FIG. 9.

In S910, after controlling a mobility device to a specified place, the autonomous driving control apparatus may obtain image data about at least one vehicle in the specified place using a sensor device.

For example, at least one sensor included in the sensor device may include at least one of a three-dimensional (3D) light detection and ranging (LiDAR), a front two-dimensional (2D) camera, a rear 2D camera, or a combination thereof.

In S920, a controller may detect location information about each of the at least one vehicle using the image data.

As an example, the controller may identify license plate information and location information of each of the at least one vehicle, using at least one of the result of sensor fusion about the image data, the result of optical character recognition (OCR) for the image data, or a combination thereof.

In S930, the controller may receive identification information corresponding to each of the at least one vehicle from a server using a communication device.

In S940, if an error between the location information and the identification information is out of a specified range, the controller may calibrate the sensor device using any one of the location information, the identification information, the error, or a combination thereof.

For example, the controller may compare the license plate information and the location information with the identification information received from the server to calculate the error.

Although not illustrated, the autonomous driving control method may further include performing, by the controller, extrinsic calibration for the at least one sensor (e.g., before controlling the mobility device to the specified place) and mapping, by the controller, point cloud data obtained using the sensor device to 2D image data based on the result of performing the extrinsic calibration and an intrinsic parameter of the at least one sensor to generate the result of sensor fusion.

According to an aspect of the present disclosure, an autonomous driving control apparatus may include a sensor device including at least one sensor, a communication device, a memory storing instructions, and a controller operatively connected with the sensor device, the communication device, and the memory. For example, the instructions may be configured to, when executed by the controller, cause the autonomous driving control apparatus to control a mobility device to a specified place and obtain image data about at least one vehicle in the specified place using the sensor device, detect location information about each of the at least one vehicle using the image data, receive identification information corresponding to each of the at least one vehicle from a server, using the communication device, and calibrate the sensor device using any one of the location information, the identification information, an error between location the information and the identification information, or a combination thereof, when the error between the location information and the identification information is out of a specified range.

The at least one sensor may include at least one of at least one three-dimensional (3D) light detection and ranging (LiDAR), a front two-dimensional (2D) camera, a rear 2D camera, or a combination thereof.

The instructions may be configured to, when executed by the controller, cause the autonomous driving control apparatus to identify license plate information and the location information of each of the at least one vehicle, using at least one of the result of sensor fusion about the image data, the result of optical character recognition (OCR) for the image data, or a combination thereof.

The instructions may be configured to, when executed by the controller, cause the autonomous driving control apparatus to compare the license plate information and the location information with the identification information received from the server to calculate the error.

The instructions may be configured to, when executed by the controller, cause the autonomous driving control apparatus to perform extrinsic calibration for the at least one sensor, before controlling the mobility device to the specified place, and map point cloud data obtained using the sensor device to 2D image data to generate the result of the sensor fusion, based on the result of performing the extrinsic calibration and an intrinsic parameter of the at least one sensor.

The identification information may include at least one of a plurality of regions of interest (ROIs) respectively corresponding to a plurality of parking areas in the specified place, at least one ROI corresponding to a parking area where at least one vehicle is parked among the plurality of ROIs, an identification number of the at least one ROI, a location of each of at least one vehicle which is parking in some of the plurality of parking areas, a vehicle number of each of the at least one vehicle, a vehicle class of each of the at least one vehicle, coordinates of each of the at least one vehicle, a width of each of the at least one vehicle, a height of each of the at least one vehicle, or a combination thereof.

The instructions may be configured to, when executed by the controller, cause the autonomous driving control apparatus to identify a driving path from a current location of the mobility device to a destination, when the error between the location information and the identification information is within the specified range, and increase a drivable maximum speed of the mobility device, when the driving path is a straight path.

The instructions may be configured to, when executed by the controller, cause the autonomous driving control apparatus to decrease a real-time driving speed of the mobility device, when the error between the location information and the identification information is out of the specified range.

The instructions may be configured to, when executed by the controller, cause the autonomous driving control apparatus to detect first location information and first license plate information of a first vehicle included in the at least one vehicle, using the sensor device, receive first identification information of the first vehicle, using the communication device, and compare the first location information with a location included in the first identification information to calculate the error, when a number included in the first identification information corresponds to the first license plate information.

The instructions may be configured to, when executed by the controller, cause the autonomous driving control apparatus to calibrate the sensor device, using at least one of a current location of the mobility device, the current location being obtained using the sensor device, a relative location between the first vehicle and the mobility device, the first location information, the first license plate information, or a combination thereof, when the error is out of the specified range.

According to an aspect of the present disclosure, an autonomous driving control system may include an autonomous driving control apparatus configured to control a mobility device to a specified place to obtain first image data about at least one vehicle in the specified place using a sensor device, detect location information about each of the at least one vehicle using the first image data, receive identification information corresponding to each of the at least one vehicle from a control server, and calibrate the sensor device using any one of the location information, the identification information, an error between the location information and the identification information, or a combination thereof, when the error between the location information and the identification information is out of a specified range, and the control server configured to obtain second image data about the at least one vehicle using at least one camera disposed in the specified place and generate the identification information corresponding to each of the at least one vehicle based on the second image data to transmit the identification information the autonomous driving control apparatus.

The control server may be configured to set a plurality of regions of interest (ROIs) respectively corresponding to a plurality of parking areas in the specified place and obtain the second image data including the plurality of ROIs, using the at least one camera.

The control server may be configured to perform optical character recognition (OCR) for at least one ROI corresponding to a parking area where the at least one vehicle is parked among the plurality of ROIs to identify a vehicle number of the at least one vehicle.

The control server may be configured to update the identification information about the at least one vehicle in the specified place, based on a specified period.

The identification information may include at least one of the plurality of ROIs respectively corresponding to the plurality of parking areas, at least one ROI corresponding to a parking area where the at least one vehicle is parked among the plurality of ROIs, an identification number of the at least one ROI, a location of each of at least one vehicle parked in the parking area, a vehicle number of each of the at least one vehicle, a vehicle class of each of the at least one vehicle, coordinates of each of the at least one vehicle, a width of each of the at least one vehicle, a height of each of the at least one vehicle, or a combination thereof.

According to an aspect of the present disclosure, an autonomous driving control method may include controlling, by a controller, y device to a specified place and obtaining, by the controller, image data about at least one vehicle in the specified place using the sensor device, detecting, by the controller, location information about each of the at least one vehicle using the image data, receiving identification information corresponding to each of the at least one vehicle from a server, using a communication device, and calibrating, by the controller, the sensor device using any one of the location information, the identification information, the an error between location information and the identification information, or a combination thereof, when the error between the location information and the identification information is out of a specified range.

The sensor device may include at least one of at least one three-dimensional (3D) light detection and ranging (LiDAR), a front two-dimensional (2D) camera, a rear 2D camera, or a combination thereof.

The detecting of the location information about each of the at least one vehicle using the image data by the controller may include identifying, by the controller, license plate information and the location information of each of the at least one vehicle, using at least one of the result of sensor fusion about the image data, the result of optical character recognition (OCR) for the image data, or a combination thereof.

The calibrating of the sensor device using any one of the location information, the identification information, the error between the location information and the identification information, or the combination thereof by the controller, when the error between the location information and the identification information is out of the specified range, may include comparing, by the controller, the license plate information and the location information with the identification information received from the server to calculate the error.

The autonomous driving control method may further include performing, by the controller, extrinsic calibration for at least one sensor included in the sensor device, before controlling the mobility device to the specified place, and mapping, by the controller, point cloud data obtained using the sensor device to 2D image data to generate the result of the sensor fusion, based on the result of performing the extrinsic calibration and an intrinsic parameter of the at least one sensor.

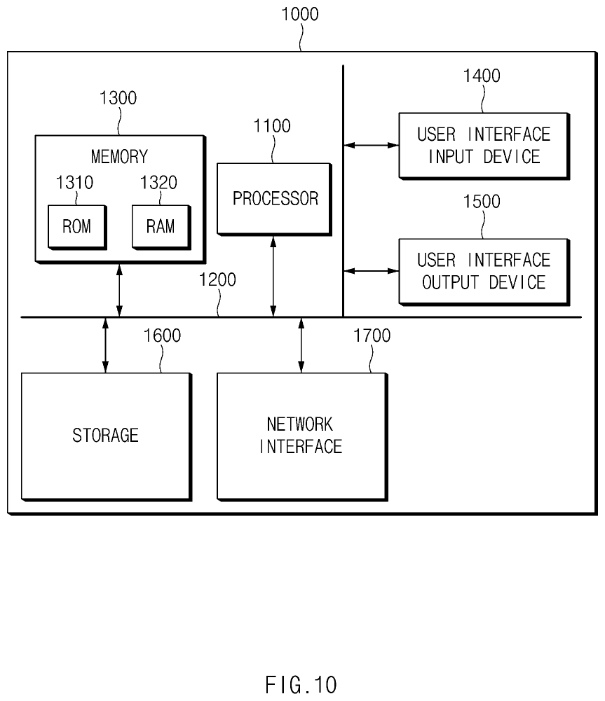

FIG. 10 illustrates a computing system for performing an autonomous driving control method.

Referring to FIG. 10, a computing system 1000 may include at least one processor 1100, a memory 1300, a user interface input device 1400, a user interface output device 1500, storage 1600, and a network interface 1700, which may be connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the operations of the method or algorithm described in connection with the features disclosed in the specification may be directly implemented with a hardware module, a software module, or a combination of the hardware module and the software module, which may be executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively or additionally, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

A description will be given of effects of the autonomous driving control apparatus and the method thereof according to the present disclosure.

According to one or more aspects of the present disclosure, the autonomous driving control apparatus may more accurately control a mobility device (or a mobile robot) to a destination (e.g., a user vehicle) using various types of image data obtained by using at least one sensor, in a situation where there are a plurality of other vehicles in the destination of the mobility device.

According to one or more aspects of the present disclosure, the autonomous driving control apparatus may calibrate the sensor device based on various pieces of data, in a place, such as an indoor parking lot and/or an outdoor parking lot, having a repeated pattern and relatively low accuracy of location estimation (or positioning), thus providing a positioning function having higher accuracy.

According to one or more aspects of the present disclosure, the autonomous driving control apparatus may control the mobility device to the destination by selectively using pieces of additional information about the destination (e.g., identification information about the at least one vehicle, which is obtained using at least one camera by the control server), even when controlling a mobile robot in a place where the accuracy of positioning data using the sensor is able to be relatively low, thus providing a movement function having high accuracy.

According to one or more aspects of the present disclosure, the autonomous driving control apparatus may increase a driving speed limit on the premise that an expected driving path of the mobility device corresponds to a straight path, when an error calculated by digitalizing positioning performance is within a specified range (e.g., a threshold range) (or when the error is within an allowable range), thus more quickly controlling the mobile robot to the destination.

According to one or more aspects of the present disclosure, the autonomous driving control apparatus may (e.g., immediately) decrease a driving speed of the mobility device, when the error calculated by digitalizing the positioning performance is out of the specified range (or when the error is out of the allowable range), thus safely controlling the mobile robot to the destination.

In addition, various effects ascertained directly or indirectly through the present disclosure may be provided.

Hereinabove, although the present disclosure has been described with reference to the accompanying drawings, aspects of the present disclosure are not limited thereto, but may be variously modified and altered by those skilled in the art to which the present disclosure pertains without departing from the spirit and scope of the present disclosure claimed in the following claims.

Therefore, aspects of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. An autonomous driving control apparatus, comprising:
a sensor device including at least one sensor;
a memory storing instructions; and
a controller operatively coupled to the sensor device and the memory,
wherein the instructions are configured to, when executed by the controller, cause the autonomous driving control apparatus to:
control a mobility device to move to a specified place and obtain, using the sensor device, image data of at least one vehicle in the specified place;
detect, using the image data, location information of the at least one vehicle;
receive identification information corresponding to the at least one vehicle; and
calibrate, based on an error identified based on the location information and the identification information being out of a specified range, the sensor device using at least one of:
the location information,
the identification information,
the error identified based on the location information and the identification information, or
a combination thereof.

2. The autonomous driving control apparatus of claim 1, wherein the at least one sensor comprises at least one of a three-dimensional (3D) light detection and ranging (LiDAR) device, a front two-dimensional (2D) camera, a rear 2D camera, or a combination thereof.

3. The autonomous driving control apparatus of claim 1, wherein the instructions are configured to, when executed by the controller, cause the autonomous driving control apparatus to:
identify license plate information and the location information of the at least one vehicle, using at least one of a result of sensor fusion about the image data, a result of an optical character recognition (OCR) for the image data, or a combination thereof.

4. The autonomous driving control apparatus of claim 3, wherein the instructions are configured to, when executed by the controller, cause the autonomous driving control apparatus to:
compare the license plate information and the location information with the identification information to calculate the error.

5. The autonomous driving control apparatus of claim 3, wherein the instructions are configured to, when executed by the controller, cause the autonomous driving control apparatus to:
perform extrinsic calibration for the at least one sensor, before controlling the mobility device to move to the specified place; and
map point cloud data obtained using the sensor device to two-dimensional (2D) image data to generate the result of the sensor fusion, based on a result of performing the extrinsic calibration and an intrinsic parameter of the at least one sensor.

6. The autonomous driving control apparatus of claim 1, wherein the identification information comprises at least one of:
a plurality of regions of interest (ROIs) respectively corresponding to a plurality of parking areas in the specified place,
at least one region of interest (ROI) corresponding to a parking area where a vehicle is parked among the plurality of ROIs,
an identification number of the at least one ROI,
a location of each of the at least one vehicle which is parked in at least one parking area of the plurality of parking areas,
a vehicle number of each of the at least one vehicle,
a vehicle class of each of the at least one vehicle,
coordinates of each of the at least one vehicle,
a width of each of the at least one vehicle,
a height of each of the at least one vehicle, or
a combination thereof.

7. The autonomous driving control apparatus of claim 1, wherein the instructions are configured to, when executed by the controller, cause the autonomous driving control apparatus to:
identify, based on the error identified based on the location information and the identification information being within the specified range, a driving path from a current location of the mobility device to a destination; and
increase, based on the driving path being a straight path, a speed of the mobility device.

8. The autonomous driving control apparatus of claim 1, wherein the instructions are configured to, when executed by the controller, cause the autonomous driving control apparatus to:
decrease, based on the error identified based on the location information and the identification information being out of the specified range, a real-time driving speed of the mobility device.

9. The autonomous driving control apparatus of claim 1, wherein the instructions are configured to, when executed by the controller, cause the autonomous driving control apparatus to:
detect, using the sensor device, first location information and first license plate information of a first vehicle of the at least one vehicle;
receive, using a communication device, first identification information of the first vehicle; and
compare, based on a number included in the first identification information corresponding to the first license plate information, the first location information with location information included in the first identification information to calculate the error.

10. The autonomous driving control apparatus of claim 9, wherein the instructions are configured to, when executed by the controller, cause the autonomous driving control apparatus to:
calibrate the sensor device by using at least one of:
a current location of the mobility device, the current location being obtained using the sensor device,
a relative location of the first vehicle relative to the mobility device,
the first location information,
the first license plate information,
or a combination thereof.

11. An autonomous driving control system, comprising:
an autonomous driving control apparatus configured to:
control a mobility device to move to a specified place to obtain, using a sensor device, first image data of at least one vehicle in the specified place,
detect, using the first image data, location information of the at least one vehicle,
receive identification information corresponding to the at least one vehicle, and
calibrate, based on an error identified based on the location information and the identification information being out of a specified range, the sensor device using at least one of the location information, the identification information, the error identified based on the location information and the identification information, or a combination thereof; and
a computing device configured to:
obtain second image data of the at least one vehicle using at least one camera disposed in the specified place,
generate, based on the second image data, the identification information corresponding to the at least one vehicle, and
transmit the identification information to the autonomous driving control apparatus.

12. The autonomous driving control system of claim 11, wherein the computing device is configured to:
set a plurality of regions of interest (ROIs) respectively corresponding to a plurality of parking areas in the specified place; and
obtain, using the at least one camera, the second image data including the plurality of ROIs.

13. The autonomous driving control system of claim 12, wherein the computing device is configured to:
perform an optical character recognition (OCR) for at least one region of interest (ROI) corresponding to a parking area where the at least one vehicle is parked among the plurality of ROIs to identify a vehicle number of the at least one vehicle.

14. The autonomous driving control system of claim 12, wherein the computing device is configured to:
update, based on a specified period, the identification information corresponding to the at least one vehicle in the specified place.

15. The autonomous driving control system of claim 12, wherein the identification information comprises at least one of:
the plurality of ROIs respectively corresponding to the plurality of parking areas,
at least one region of interest (ROI) corresponding to a parking area where a vehicle is parked among the plurality of ROIS,
an identification number of the at least one ROI,
a location of each of the at least one vehicle parked in at least one parking area of the plurality of parking areas,
a vehicle number of each of the at least one vehicle,
a vehicle class of each of the at least one vehicle,
coordinates of each of the at least one vehicle,
a width of each of the at least one vehicle,
a height of each of the at least one vehicle, or
a combination thereof.

16. An autonomous driving control method, comprising:
controlling, by a controller, a mobility device to move to a specified place;
obtaining, by the controller and using a sensor device, image data of at least one vehicle in the specified place;
detecting, by the controller and using the image data, location information of the at least one vehicle;
receiving identification information corresponding to the at least one vehicle; and
calibrating, by the controller and based on an error identified on the location information and the identification information being out of a specified range, the sensor device using at least one of:
the location information,
the identification information,
the error identified based on the location information and the identification information, or
a combination thereof.

17. The autonomous driving control method of claim 16, wherein the sensor device comprises at least one of a three-dimensional (3D) light detection and ranging (LiDAR) device, a front two-dimensional (2D) camera, a rear 2D camera, or a combination thereof.

18. The autonomous driving control method of claim 16, wherein the detecting of the location information comprises:
identifying, by the controller, license plate information and the location information of the at least one vehicle, using at least one of a result of sensor fusion about the image data, a result of an optical character recognition (OCR) for the image data, or a combination thereof.

19. The autonomous driving control method of claim 18, wherein the calibrating of the sensor device comprises:
comparing, by the controller, the license plate information and the location information with the identification information to calculate the error.

20. The autonomous driving control method of claim 18, further comprising:
performing, by the controller, extrinsic calibration for at least one sensor of the sensor device, before controlling the mobility device to move to the specified place; and
mapping, by the controller, point cloud data obtained using the sensor device to two-dimensional (2D) image data to generate the result of the sensor fusion, based on a result of performing the extrinsic calibration and an intrinsic parameter of the at least one sensor.
